(19) United States
(12) Patent Application Publication
(10) Pub. No.: US 2011/0145758 A1
(43) Pub. Date: Jun. 16, 2011

(54) DISPLAY NAVIGATION SYSTEM, METHOD AND COMPUTER PROGRAM PRODUCT

(75) Inventors: Jacob J. ROSALES, Austin, TX (US); Luis A. Garcia, Austin, TX (US); Jason J. Jaramillo, Austin, TX (US); Jorge A. Rasillo, Round Rock, TX (US)

(73) Assignee: INTERNATIONAL BUSINESS MACHINES CORPORATION, Armonk, NY (US)

(21) Appl. No.: 12/635,413

(22) Filed: Dec. 10, 2009

(51) Int. Cl. G06F 3/048

(52) U.S. Cl. 715/794; 715/862

(57) ABSTRACT

According to one aspect of the present disclosure a method and technique for navigating between windows is disclosed. The method includes providing a graphic user interface (GUI) including a plurality of windows ordered along a depth (Z) axis. The method also includes, responsive to receiving a window re-order keystroke input, determining a location of each window relative to a position of a pointer icon in the GUI and setting a window re-ordering sequence for re-ordering a Z-position of the windows in the GUI based at least partly on a location of the windows relative to the position of the pointer icon in the GUI.

### BACKGROUND

A windows-based graphical user interface (GUI) used in conjunction with a multitasking operating system enables different applications to run concurrently in multiple corresponding windows. The windows are generally arranged on a display screen interface as multiple layers or stacks of overlapping windows such that the selected or active window is raised to the top of the stack (considered the highest Z-order level in the GUI environment). A user may change the Z-order of windows by selecting a different window or shuffling through the windows using short-cut keystrokes (e.g., ALT-TAB/ALT-SHIFT-TAB) which shuffles the active window based on the order of when the window was last accessed or active.

### BRIEF SUMMARY

According to one aspect of the present disclosure a method and technique for navigating between windows is disclosed. The method includes providing a graphic user interface (GUI) including a plurality of windows ordered along a depth (Z) axis. The method also includes, responsive to receiving a window re-order keystroke input, determining a location of each window relative to a position of a pointer icon in the GUI and setting a window re-ordering sequence for re-ordering a Z-position of the windows in the GUI based at least partly on a location of the windows relative to the position of the pointer icon in the GUI.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system in which a window navigation system may be implemented;

FIG. 4 is a diagram illustrating an embodiment of a graphic user interface (GUI);

FIG. 5 is a diagram illustrating an embodiment of a window re-ordering sequence; and

FIG. 6 is a flow diagram illustrating an embodiment of a window navigation method.

### DETAILED DESCRIPTION

Embodiments of the present disclosure provide a method, system and computer program product for shuffling or cycling through windows in a display environment. For example, in some embodiments, in a data processing system having an operating system displaying a graphic user interface (GUI) with a number of windows arranged in a stacked or overlapping arrangement, the system enables using shortcut keystroke inputs to shuffle the active/inactive states of the windows based at least partly on a distance between a particular window and a location of a pointer icon in the GUI (e.g., an icon corresponding to a mouse-like input device). Thus, in some embodiments, the sequence the windows are arranged for shuffling or cycling through the windows is based on how close the window is to the pointer icon in the GUI. In some embodiments, the windows that are located closest to and/or intersect the location of the pointer icon are ordered first in the sequence, followed by windows located farther away from the pointer icon. Thus, in some embodiments, in response to a shortcut keystroke input, the sequence or order the windows are arranged for shuffling there through is based at least partly on a relative distance of the respective window to the pointer device icon.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

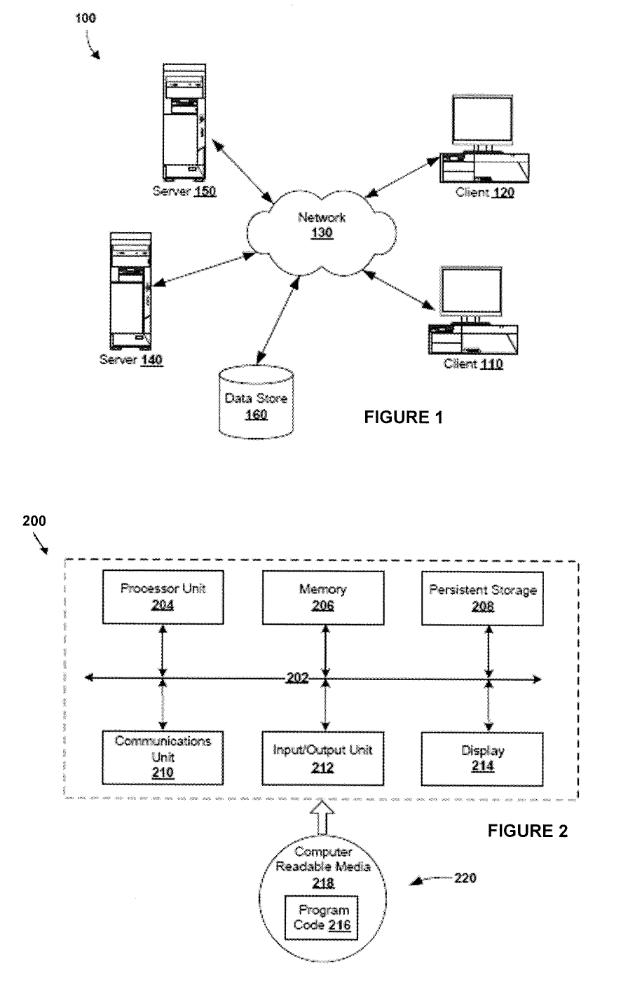

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM System p® servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 in which an embodiment of a window navigation application according to the present disclosure may be implemented. In this embodiment, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

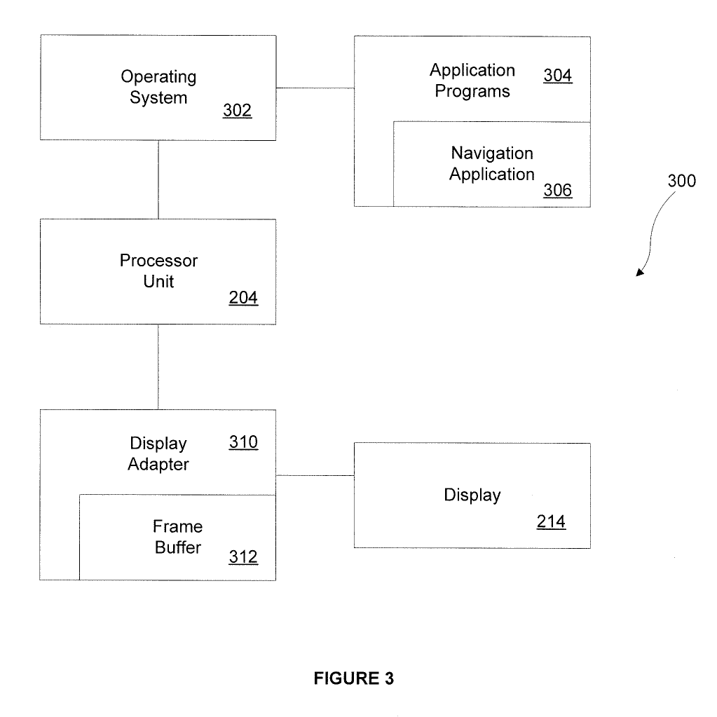

FIG. 3 is an embodiment of a window navigation system 300. Navigation system 300 may be implemented on a data processing system or platform such as, but not limited to, client 110 depicted in FIG. 1 and form part of system 200 depicted in FIG. 2. In the embodiment illustrated in FIG. 3, an operating system 302 runs on processor unit 204 and provides control and is used to coordinate the function of the various components of FIG. 2. Operating system 302 may be one of the commercially available operating systems, such as IBM's AIX 6000™ operating system or Microsoft's WindowsXP™ or Windows2000™ operating systems, or may be another operating system. Application programs 304, controlled by the system, are moved into and out of memory (e.g., memory 206 depicted in FIG. 2), including a navigation application program 306 of the present disclosure for sorting through a stack of windows displayed on display device 214. Display adapter 310 includes a frame buffer 312 that is a storage device that holds a representation of each pixel on display 214. Images may be stored in frame buffer 312 for display on display 214. For example, in a GUI environment, applications may run in separate windows, any one of which may be active at a time. The windows are arranged in apparent stacks in the GUI environment along what is considered a Z-axis such that the highest Z-order level represents the active window with inactive windows located in lower Z-order levels. As each window is accessed or selected, thereby changing the window status to active, its Z-order level is raised while other windows are lowered in the Z-order level (e.g., the most recently accessed window in the highest Z-order level (e.g., appearing closest to the user) with inactive windows extending downward along the Z-axis to lower Z-order levels (e.g., appearing farthest from the user) based on the last time the respective window was accessed).

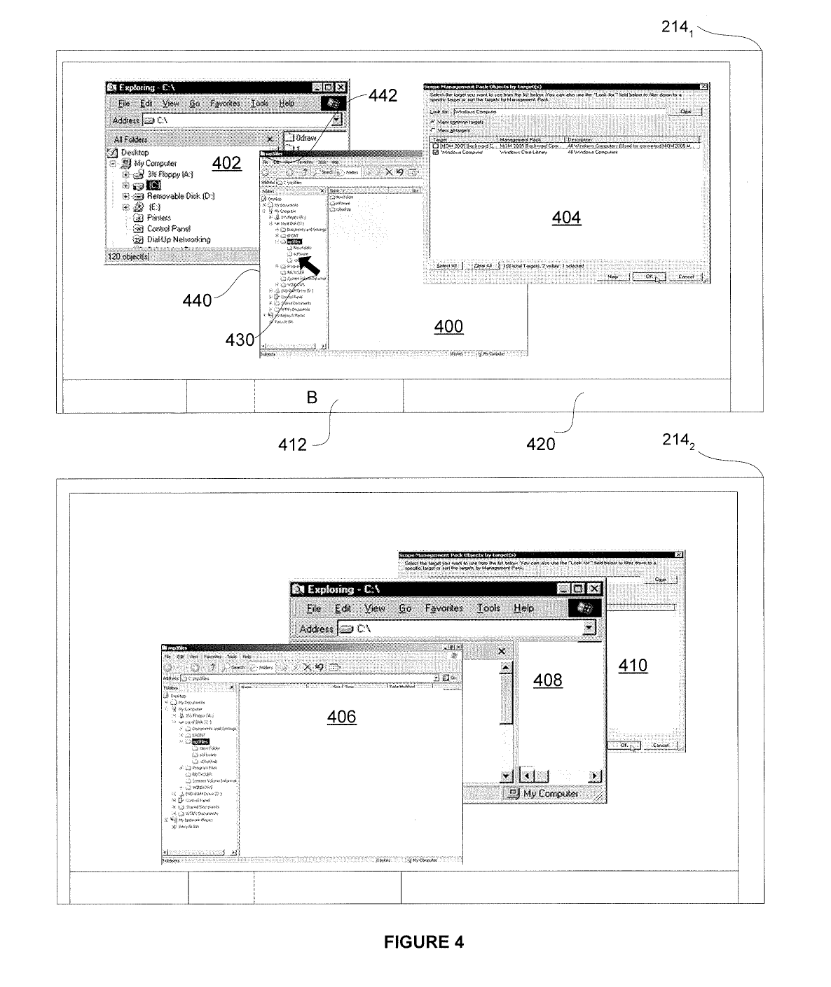

FIG. 4 is a diagram illustrating a display interface having several windows displayed thereon. In FIG. 4, the GUI desktop environment extends across multiple displays 214, indicated as display 214₁ and 214₂. It should be understood that the GUI environment may be displayed on a single display or extending across a greater number of displays. In FIG. 4, windows 400, 402, 404 and 412 are displayed on display 214₁ with window 412 minimized and residing graphically along a task bar 420. Windows 406, 408 and 410 are displayed on display 214₂. As illustrated in FIG. 4, windows 400, 402, 404, 406, 408 and 410 are displayed in a stacking or overlapping arrangement with each window having a particular Z-order level within the GUI display environment. It should also be understood that one or more windows may not overlap or be obscured by another window in the GUI environment while still remaining within a particular Z-order level relative to other windows in the GUI environment. In this illustrative example, based on recent access to each window in the displayed GUI environment, the Z-order of the windows is window 406, 408, 410, 404, 400, and 402 (with window 412 minimized and residing graphically along task bar 420). In this illustrative example, window 406 is located at the highest Z-order level and is the active window in the displayed GUI Environment.

In FIG. 4, a pointer icon 430 is displayed in display 214₁. Pointer icon 430 comprises the displayed location of a pointer corresponding to an input device such a mouse or trackpad. According to aspects of the present disclosure, a sequence or order of windows for changing or shuffling through the various windows (e.g., for selecting a different window to be the active window) using a shortcut keystroke command or input is based at least partially on the location of each window in the GUI relative to the position of the pointer of pointer icon 430. For example, in some embodiments, in response to receiving a window re-order keystroke input (e.g., via a keyboard or other type of input device), a distance between each window and the location of pointer icon 430 in the GUI is determined and the windows are ordered or sequenced based on the determined distances. In some embodiments, the sequence or order of windows may be defined from the shortest distance to the furthest distance from the position of the pointer icon 430. In this example, windows nearest to and/or intersecting a location or position of pointer icon 430 would be located at the beginning of the sequence followed by windows non-intersecting a location of pointer icon 430.

Referring to FIG. 4, the position of pointer icon 430 located in display 214₁ intersects windows 400 and 402. According to some embodiments of the present disclosure, windows intersecting a position of pointer icon 430 are located at the beginning of the re-order sequence followed by non-intersecting windows from nearest to the position of pointer icon 430 to the furthest distant from the position of pointer icon 430. Thus, in this illustrative example, the sequence or order for re-ordering a Z-position of windows would be window 400, 402, 404, 406, 408, 410, and 412. Further, if it is determined that two or more windows intersect a position of pointer icon 430, the intersecting window to place first in the sequence maybe derived using different methods. For example, in some embodiments, if multiple windows intersect a position of pointer icon 430, the first intersecting window placed in the re-order sequence may be the window having an edge (e.g., edge 440) located closest to the position pointer icon 430. In other embodiments, the intersecting window placed first in the re-order sequence may be the intersecting window having the location of pointer icon 430 located most closely to the center of the corresponding intersecting window. And yet other embodiments, the intersecting window placed first in the re-order sequence may be the window having a corner (e.g., corner 442) located closest to the position of pointer icon 430 (e.g., upper left hand corner, upper right hand corner, lower left hand corner, or lower right hand corner). In some embodiments, in response to determining that multiple windows intersect a position pointer icon 430, the order sequence for the intersecting windows may be based on last access to the intersecting window or the current Z-level of the window. For example, in the illustrative example of a FIG. 4, window 400 has a higher Z-order level than window 402. Thus, in some embodiments, intersecting windows may be ordered in the sequence based on their Z-order position.

In some embodiments, non-intersecting windows may be placed in the re-order sequence based on their Z-order level. For example, in the illustrative example of FIG. 4, the Z-order position of non-intersecting windows is window 406, 408, 410 and 404. Thus, in some embodiments, intersecting windows would be placed at the beginning of the re-order sequence followed by non-intersecting windows based on their Z-order position. Accordingly, in this embodiment, the re-order sequence would be window 400, 402, 406, 408, 410, 404 and 412. It should be understood that the non-intersecting windows may also be placed in the re-order sequence based on other criteria such as, but not limited to, the relative distance between the position of pointer icon 430 and an edge of the non-intersecting window, a corner of the non-intersecting window, the center of the non-intersecting window, or other feature of the non-intersecting window.

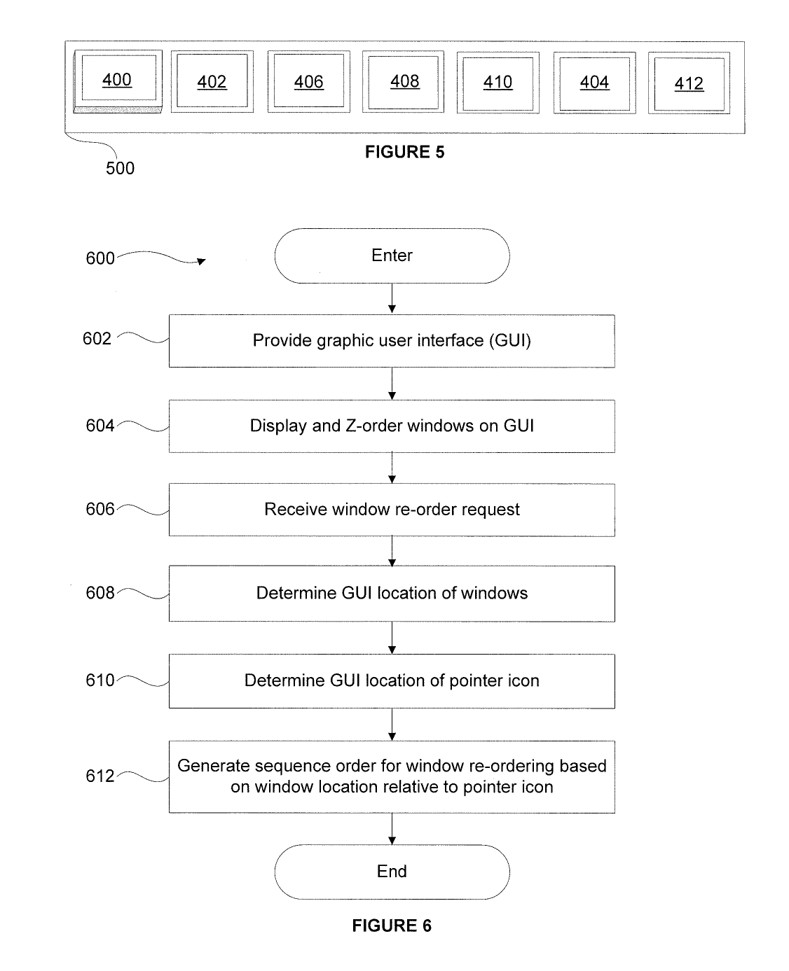

FIG. 5 is a diagram illustrating a pop-up window that may be displayed on display 214 in response to a window re-order input or request. In FIG. 5, the sequence through which a user may cycle or shuffle through windows to make a different window an active window is graphically illustrated. In some embodiments, a particular keystroke input may cause window 500 to appear displaying to the user a re-order sequence for windows based on the position of pointer icon 430 relative to each window. In this example, windows intersecting pointer icon 430 are placed at the beginning of the sequence based on their Z-order level followed by non-intersecting windows placed in the sequence based on their Z-order position. Thus, using this method, and referring to FIG. 4, the re-order sequence is window 400, 402, 406, 408, 410, 404, and 412. In the above examples, a minimized or non-displayed window follows displayed windows; however, it should be understood that the sequence order for non-displayed windows may be varied. It should be understood that, using the display window 500, a user may cycle and/or shuffle in either direction through the re-order sequence to select a desired window to become the active window.

FIG. 6 is a flow diagram illustrating a window navigation method. The method begins at block 602 where a graphic user interface is displayed on a display device such as display 214. At block 604, windows are displayed on the GUI environment in a Z-order arrangement. At block 606, a window re-order request is received, such as by a short cut keystroke command (e.g., ALT-TAB/ALT-SHIFT-TAB). At block 608, the location of each window and/or various features of each window in the GUI is determined. At block 610, a location of pointer icon 430 in the GUI is determined. At block 612, a window re-order sequence is generated based on a position of pointer icon 430 in the GUI environment relative to a location of each corresponding window. As described above, windows intersecting the location of pointer icon 430 are located at the beginning of the re-order sequence followed by non-intersecting windows. The sub-ordering of intersecting and non-intersecting windows (e.g., when multiple windows intersect or non-intersect) within the re-order sequence maybe varied as described above (e.g., by Z-order position, by edge/corner/center relative to pointer icon 430, etc.).

Thus, embodiments of the present disclosure provide a method, system and computer program product for shuffling or cycling through windows in a display environment based at least partly on a distance between a particular window and a location of a pointer icon in the GUI. Thus, in some embodiments, the sequence the windows are arranged for shuffling or cycling through the windows is based on how close the window is to the pointer icon in the GUI. Thus, embodiments of the present disclosure enable a shuffling sequence of windows related more closely to where a user may be working in a particular display environment (e.g., as indicated by the position of a pointer icon in the display environment).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
providing a graphic user interface (GUI) including a plurality of windows ordered along a depth (Z) axis;
responsive to receiving a window re-order keystroke input, determining a location of each window relative to a position of a pointer icon in the GUI; and
setting a window re-ordering sequence for re-ordering a Z-position of the windows in the GUI based at least partly on a location of the windows relative to the position of the pointer icon in the GUI.

2. The method of claim 1, further comprising, in response to determining that a location of a window indicates an intersection of the window with the position of the pointer icon, placing the intersecting window at a beginning of the sequence.

3. The method of claim 1, further comprising, in response to determining that a plurality of windows intersect the position of the icon, placing the intersecting window having an edge located nearest the position of the pointer icon at a beginning of the sequence.

4. The method of claim 1, further comprising, in response to determining that a plurality of windows intersect the position of the icon, placing the intersecting window having the position of the pointer icon nearest the center of the intersecting window at a beginning of the sequence.

5. The method of claim 1, further comprising, in response to determining that a plurality of windows intersect the position of the icon, placing the intersecting windows at a beginning of the sequence according to their Z-position in the GUI followed by windows non-intersecting the position of the pointer icon.

6. The method of claim 1, wherein setting the window re-ordering sequence comprises ordering the windows from least distance to greatest distance relative to the position of the pointer icon.

7. The method of claim 1, wherein setting the window re-ordering sequence comprises placing the windows intersecting the position of the pointer icon in the sequence before the windows non-intersecting the position of the pointer icon.

8. The method of claim 1, further comprising, in response to successive window re-order keystroke inputs:
cycling through and respectively raising a Z-position of each window intersecting the position of the pointer icon; and
in response to determining that each intersecting window has had its Z-position changed, cycling through and respectively changing a Z-position of each non-intersecting window.

9. A system, comprising:
a display device;
at least one input device; and
a processor programmed to display a graphic user interface (GUI) on the display device including a plurality of windows and a pointer icon corresponding to the at least one input device, wherein the plurality of windows are ordered along a depth (Z) axis, and wherein the processor is programmed to:
receive a window re-order keystroke input;
determine a location of each window relative to a position of the pointer icon on the GUI; and;
set a window re-ordering sequence for re-ordering a Z-position of the windows in the GUI based at least partly on a location of the windows relative to the position of the pointer icon in the GUI.

10. The system of claim 9, wherein the processor is programmed to, in response to determining that a location of a window indicates an intersection of the window with the position of the pointer icon, place the intersecting window at a beginning of the sequence.

11. The system of claim 9, wherein the processor is programmed to, in response to determining that a plurality of windows intersect the position of the icon, place the intersecting window having the position of the pointer icon nearest the center of the intersecting window at a beginning of the sequence.

12. The system of claim 9, wherein the processor is programmed to, in response to determining that a plurality of windows intersect the position of the icon, place the intersecting windows at a beginning of the sequence according to their Z-position in the GUI followed by windows non-intersecting the position of the pointer icon.

13. The system of claim 9, wherein the processor is programmed to set the window re-ordering sequence by ordering the windows from least distance to greatest distance relative to the position of the pointer icon.

14. The system of claim 9, wherein the processor is programmed to set the window re-ordering sequence by placing the windows intersecting the position of the pointer icon in the sequence before the windows non-intersecting the position of the pointer icon.

15. The system of claim 9, wherein the processor is programmed to, in response to successive window re-order keystroke inputs:
cycle through and respectively raise a Z-position of each window intersecting the position of the pointer icon; and
in response to determining that each intersecting window has had its Z-position changed, cycle through and respectively change a Z-position of each non-intersecting window.

16. A computer program product for navigating between windows in a display, the computer program product comprising:
a computer readable storage medium having computer readable program code embodied therewith, the computer readable program code comprising computer readable program code configured to:
display a graphic user interface (GUI) on a display device including a plurality of windows and a pointer icon corresponding to at least one input device, wherein the plurality of windows are ordered along a depth (Z) axis;
responsive to detecting a window re-order keystroke input, determine a location of each window relative to a position of a pointer icon in the GUI; and
set a window re-ordering sequence for re-ordering a Z-position of the windows in the GUI based at least partly on a location of the windows relative to the position of the pointer icon in the GUI.

17. The computer program product of claim 16, wherein the computer readable program code is configured to set the window re-ordering sequence by placing the windows intersecting the position of the pointer icon in the sequence before the windows non-intersecting the position of the pointer icon.

18. The computer program product of claim 16, wherein the computer readable program code is configured to, in response to determining that a plurality of windows intersect the position of the icon, place the intersecting windows at a beginning of the sequence according to their Z-position in the GUI followed by windows non-intersecting the position of the pointer icon.

19. The computer program product of claim 16, wherein the computer readable program code is configured to, in response to determining that a location of a window indicates an intersection of the window with the position of the pointer icon, place the intersecting window at a beginning of the sequence.

20. The computer program product of claim 16, wherein the computer readable program code is configured to, in response to successive window re-order keystroke inputs:
cycle through and respectively raise a Z-position of each window intersecting the position of the pointer icon; and
in response to determining that each intersecting window has had its Z-position changed, cycle through and respectively change a Z-position of each non-intersecting window.
